(19) United States
(12) Patent Application Publication
(10) Pub. No.: US 2026/0328694 A1
(43) Pub. Date: Oct. 22, 2026

(54) SYSTEM FOR MEASURING A CENTRAL WAVELENGTH OF A SPECTRAL LINE WITH HIGH ACCURACY AND ASSOCIATED METHOD

(71) Applicant: COMMISSARIAT À L'ENERGIE ATOMIQUE ET AUX ENERGIES ALTERNATIVES, PARIS (FR)

(72) Inventors: Jean-Baptiste SIRVEN, PARIS (FR); Kévin TOUCHET, ESPIRA-DE-L'AGLY (FR); Frédéric CHARTIER, FONTENAY-AUX-ROSES (FR)

(21) Appl. No.: 19/111,266

(22) PCT Filed: Sep. 20, 2023
(86) PCT No.: PCT/EP2023/075943

§ 371 Date: Mar. 12, 2025

(30) Foreign Application Priority Data
Sep. 21, 2022 (FR) 2209563

(51) Int. Cl. G01N 21/71

(52) U.S. Cl. CPC G01N 21/718; G01N 2201/06113; G01N 2201/08

(57) ABSTRACT

A system, for measuring a central wavelength of interest of a spectral line of interest measured by a spectrometer, includes: a detecting system including a spectrometer associated with a detector; a Y-shaped optical fiber configured such that: the first entrance collects a light signal generated by the sample, called the sample signal, the second entrance collects a light signal generated by a reference source, called the reference signal, the exit is coupled to an input of the spectrometer, the measuring system being configured so that the detector detects the sample signal and the reference signal simultaneously or sequentially in time; the measuring system further including a processing unit configured to: process the measured profile of interest and measured reference profile, determine a value of the central wavelength of interest on the basis of a difference between the position of interest and reference position, of the known value of the reference wavelength and of a linear dispersion (DL) of the detecting system.

### CROSS-REFERENCE TO RELATED APPLICATIONS

This application is a National Stage of International patent application PCT/EP2023/075943, filed on Sep. 20, 2023, which claims priority to foreign French patent application No. FR 2209563, filed on Sep. 21, 2022, the disclosures of which are incorporated by reference in their entireties.

### FIELD OF THE INVENTION

The present invention relates to the field of spectroscopy, and more particularly to determining the central wavelength of a spectral line with very high precision.

### BACKGROUND

In certain applications in spectroscopy, for example atomic or molecular spectroscopy, or to determine the isotopic abundance of an element in a sample via one optical method (called LIBRIS, Laser Induced Breakdown self-Reversal Isotopic Spectrometry, see below), it is necessary to determine the value of the central wavelength of a spectral line with a high precision. The spectral line to be characterized is produced by a light source and may be an atomic or molecular, absorption or emission line. Typically, an uncertainty of less than 5 pm, or even less than 1 pm, in the value of the central wavelength is sought.

This problem has not yet arisen in the field of laser induced breakdown spectroscopy (LIBS) or laser ablation molecular isotopic spectrometry (LAMIS), etc. because the width of the observed lines is typically a few tens of pm. The wavelength of the lines is therefore usually measured with an uncertainty of about ten pm to a few tens of pm depending on the linear dispersion of the spectrometer used. This uncertainty has no impact on these techniques because the analysis carried out is based on the intensity of the lines, which is generally integrated over a width of the same order, i.e. of about ten to a few tens of pm.

Conventionally, the detecting system is calibrated in respect of wavelength by means of a reference source emitting known lines, typically a mercury-vapor lamp or a hollow-cathode lamp. The position of the line to be analyzed and the position of the reference line are identified in pixels on the detector, and the line to be analyzed is determined from its relative position with respect to the position of the reference line. The detector comprises at least N pixels Pi aligned in a row, with i varying from 1 to N. When it is 2D, an integration over all the pixels of a given column is performed. For example, the detector is CCD matrix array, with 2048×512 pixels.

Let λref be the central wavelength of the reference line and λ0 the wavelength to be determined, Pref the position of λref in detector pixels and P0 the position of λ0 on the same detector. The wavelength λref is of course selected so that it appears on the detector simultaneously with λ0 for a given spectrometer configuration. The following is then valid:

λ₀=λ_{ref}+(P₀−P_{ref})·DL (1)
with DL the linear dispersion of the detecting system, typically in pm/pixel.

For various reasons (thermal fluctuations, vibrations), spectrometers and detectors drift very slightly even in the controlled environment of a research laboratory, leading to wavelength drift. This drift is of course even more pronounced in the case of analysis outside the laboratory (in the field, online, by a portable system, etc.). By way of example, in the case of a grating spectrometer of 1 m focal length with a grating having 2400 lines/mm, a variation of only 10⁻³ degrees in the angle of the grating causes a wavelength shift of 10 μm, this being unacceptable for LIBRIS analysis, of lithium for example, where an uncertainty of less than 1 μm is targeted to obtain an acceptable uncertainty in the isotopic abundance of ⁶Li.

The reference line and the line to be analyzed are detected sequentially in time. In the commonest case, the signal generated by the sample is conveyed to the detecting system by an optical fiber. To perform the two measurements, it is then necessary to position the optical fiber connected to the spectrometer to first collect the light flux generated by the reference source and to then collect the light flux generated by the emission to be characterized or vice versa, this taking some time. Typically, these two measurements are separated by a duration of the order of one minute, which is a sufficient amount of time for such a drift to occur.

It is therefore impossible to take accurate LIBRIS measurements without correcting the detecting system for wavelength drift. The problem arises in the same way in atomic spectroscopy, where it is sought to measure 20 accurately via calibration with a reference source.

Since the invention is particularly advantageous in the context of the LIBRIS method, its principle and the principle of the LIBS and LAMIS methods are recalled below.

The principle of LIBS technology, as illustrated in FIG. 1, is to focus a laser pulse on the surface of a sample of material (or on the material itself) to generate a transient plasma the light emission of which is analyzed by means of a spectrometer. By collecting the light emission of the plasma and analyzing its spectrum by spectrometry, it is possible to identify the elements present in the plasma, and therefore to determine the composition of the material, using databases of emission lines. In LIBS the intensity is integrated over the entire width of the line.

The LAMIS technology, which is for example described in the publication by R. Russo et al., Spectrochim. ACTA B 66 (2011) 99, is an alternative derived from LIBS that allows an isotopic analysis to be carried out on the basis of the lines of molecules formed by reaction between ablated material and a constituent of the ambient medium, or by reaction between two atoms of the ablated material.

A laser generator L0 generates a laser beam FLO that is focused on the sample 1 by virtue of a first optical system 2. This generates a plasma PIO. The plasma emits a light emission 3, which is collected by an optical system OSO. The focused light emission is sent to a spectrometer Spec0 via an optical fiber FO. The spectrometer Spec0 comprises (or is associated with) a detector Det0 synchronized with the laser generator L0. The spectrometer Spec0 allows line spectra to be recorded. Lastly, processing means UTO allow the recorded spectra to be processed.

LIBS allows a spectrum 20 to be generated, which takes the form of a set of spectral lines corresponding to the emission lines of the constituent elements of the material, and allows—using the available data correlating emission lines and elements—the elemental composition of the sample of material to be determined. The wavelength λ of a line provides information on one element present in the material and its intensity I is related to the concentration of this element.

LIBS emission spectrometry is also applicable to isotopic analysis because the atomic lines of various isotopes of the same element have slightly different wavelengths. This spectral shift, called isotopic shift, is due to mass effects (predominant in the case of light elements) and to modification of the distribution of charge inside the nucleus (predominant in the case of heavy elements). If it is desired to carry out isotopic analysis by LIBS, it is essential to split the lines of the 2 isotopes. However, this spectral shift is generally of the order of a fraction of nm or even a few pm, as shown in table I below:

TABLE I

| Isotopes | Emission line | Isotopic shift |
|---|---|---|
| 7 Li → 6 Li | 670.775 nm | + 15.8 pm |
| 10 B → 11 B | 208.891 nm | − 2.5 pm |
| 238 U → 235 U | 424.437 nm | + 25 pm |
| 239 Pu→ 240 Pu | 594.522 nm | + 13 pm |

Such a shift is difficult to observe in a plasma generated by laser ablation under normal conditions, because the confinement of the plasma by ambient air at atmospheric pressure leads to a high density, and therefore to a broadening of the emission lines due to the Stark effect. This broadening commonly reaches several tens or even hundreds of pm and therefore masks the isotopic shift, even if the spectrometer used has a spectral resolution sufficient to resolve this shift. The limitation is here physical and not instrumental in nature.

A first solution consists in carrying out the analysis at low pressure, or even under vacuum. By thus limiting the confinement of the plasma by the ambient medium, its density is decreased and a spectral selectivity sufficient for certain isotopes may be achieved. A double line is observed, and the isotopic ratio is determined from the intensity ratio between the two lines associated with the two isotopes. This approach is not applicable to all isotopes and requires a spectrometer that has a high resolving power, and that therefore is bulky. A second solution consists in sending a second laser beam through the plasma, in order to measure a resonant or fluorescence absorption signal, this being constraining and complexifying the measuring system.

In the art of isotopic analysis at atmospheric pressure, it is also possible to use the LAMIS technique, but this requires a number of conditions to be met: 1. it is necessary for molecules to form in the plasma; 2. it is necessary for the molecules formed to be sufficiently stable under the temperature/density conditions of the plasma; and 3. it is necessary for the molecules formed to have detectable lines, i.e. lines that have a sufficient lifespan, that are sufficiently intense, and that lie in the spectral band of the detecting system. In the case of lithium, for example, no LAMIS signal is detected, probably because the 2nd condition is not met.

The LIBRIS technique is an optical technique allowing the isotopic abundance of an element in a (solid, liquid or gas) sample to be determined from the emission spectrum of a laser ablation plasma. This technique is for example described in the publication by K. Touchet et al., Spectrochim. ACTA B 168 (2020) 105868 and in document US 2019/0041336. It is a variant of the LIBS technology and uses the same optical system. The LIBRIS technology allows the various drawbacks of the LIBS method to be overcome by allowing a measurement of an isotopic ratio to be taken at atmospheric pressure and without a second laser.

It will be recalled that energy must be supplied for the electrons of atoms to transition to higher energy levels. This energy may take the form of photons, in which case the atom absorbs photons. One particular case is that of laser ablation plasma. To simplify matters, the plasma may be considered to consist of two separate parts, a core and a periphery. Photons emitted by the warmer plasma core may be absorbed by the colder periphery. This effect therefore prevents a certain number of emitted photons from leaving the plasma: it is called self-absorption.

To an observer outside the plasma, and to a measuring apparatus, the line profile results from emission and self-absorption at the same wavelength, corresponding to transitions between two levels of electrons of all the atoms in question placed on her, his or its line of sight. Consequently, the measured intensity is not merely the sum of all the emissions from the plasma, as such self-absorption must be taken into account.

The self-absorption effect, which is well known in spectroscopy of plasmas for elemental analysis, is rather considered to be an undesirable effect because it leads to distortion of the line profile, and therefore to a non-linearity in the signal with respect to the concentration of the element of interest. LIBRIS exploits this self-absorption effect to deduce therefrom information on the isotopes of a given element in a material.

FIGS. 2 and 3 illustrate, selected from a spectrum 20, a line RSO of an element of interest obtained in two particular cases, depending on the concentration of the element in the material.

FIG. 2 illustrates the case where the concentration of the element in the plasma is lower, the effect of self-absorption being little marked or even absent. A spectrally broad line profile that does not have a trough at its center is obtained. The dotted and dashed curves ISO₁ and ISO₂ represent the emission of the 2 isotopes. Each line has a width that is broad with respect to the separation between the 2 lines, mainly because of the Stark effect in the plasma, and hence they are not distinguishable individually: the solid line RSO, which corresponds to the sum of the 2 lines, is detected. The principle of LIBRIS is that the central wavelength of the solid line varies with isotopic abundance, i.e. with the ratio of the amplitudes of the 2 dotted and dashed lines. In this case, the value of the central wavelength 20 is measured, the central wavelength corresponding to the emission peak, i.e. to the maximum point or apex 20 of the observed curve, which has a bell profile. It is correlated with the ratio between two isotopes Iso₁ and Iso₂ of the element in question, and it is shifted depending on said isotopic ratio.

FIG. 3 illustrates the case where concentration of the element in the plasma is high, the effect of self-absorption being marked. A line profile that has a trough at its center (double bell profile) is observed, this profile being called a reversed line and resulting from superposition of a spectrally broad emission profile and a spectrally narrower absorption profile. In this case, the value of the central wavelength 2 corresponding to the absorption trough is measured. The central wavelength 20 is in this case measured on the part of the profile corresponding to the absorption, i.e. at the minimum point 30 of the observed trough. It is correlated with the ratio between two isotopes Iso₁ and Iso₂ of the element in question, and it is shifted depending on said isotopic ratio. It is this measurement of the wavelength of the trough that defines the LIBRIS technology.

Thus, in LIBRIS technology, the isotopic ratio is measured on the basis of very precise measurement of the wavelength 20 of the maximum of the bell line or of the minimum of the so-called reversed double bell line. This wavelength λ₀ shifts linearly with isotopic abundance, between λ_{R}¹ and λ_{R}², the indices 1 and 2 referring to two isotopes of the element. λ_{R}¹ and λ_{R}² are physical data available in spectroscopic databases and/or scientific publications. The analytical uncertainty in the isotopic abundance is therefore directly related to the uncertainty in the wavelength λ0.

In the LIBRIS technology, measurement of λ0 yields the isotopic ratio directly. FIG. 4 illustrates the variation in the measured λ0 as a function of the proportion of the isotope ⁶Li of lithium, which has only two isotopes ⁶Li and ⁷Li. This curve was produced using a reversed line. The isotopic shift is given by λ_{R}¹-λ_{R}² and corresponds to the measurement range of the technique for a given line. In the case of lithium and for the line at 670.778 nm used in LIBRIS, this shift is 15.8±0.3 μm and therefore corresponds to the total variation of the isotopic abundance of ⁶Li from 0% to 100%, the complement being the abundance of ⁷Li. Thus, an uncertainty of 1 μm in the wavelength λ_{R} leads to an uncertainty in the isotopic abundance of 1/15.8=6.3%. The precision of measurement of the isotopic ratio is therefore directly correlated with the precision of the measurement of λ0.

### SUMMARY OF THE INVENTION

One aim of the present invention is to remedy the aforementioned drawbacks by proposing a method and system for determining the central wavelength of an, atomic or molecular, absorption or emission line produced by a light source, with sub-picometer precision.

One subject of the present invention is a system for measuring a central wavelength of interest of a spectral line of interest measured by a spectrometer, the spectral line of interest corresponding to emission or absorption by a sample to be characterized, a light signal generated by the sample being called the sample signal, the spectral line of interest having either a bell profile, said central wavelength of interest then corresponding to the apex of said bell profile, or a double bell profile, said central wavelength of interest then corresponding to the trough between the two bells, the system comprising:
a detecting system comprising a spectrometer associated with a detector comprising a plurality of pixels aligned in an X-direction, the spectral line of interest being detected on detector pixels,
   a reference source emitting a light signal, called the reference signal, the reference source having a reference spectral line having a central wavelength, called the reference wavelength, of known value, the reference wavelength being selected so as to be detected on at least one pixel of the detector,
   a Y-shaped optical fiber having a first entrance, a second entrance and an exit, the optical fiber being configured such that:
      the first entrance collects said sample signal,
      the second entrance collects said reference signal,
      the exit is coupled to an input of the spectrometer,
the measuring system being configured so that the detector detects said sample signal and said reference signal simultaneously or sequentially in time, so as to generate a measured profile of interest and a measured reference profile, the measuring system further comprising a processing unit configured to:
   process said measured profile of interest and measured reference profile so as to determine a position of interest and a reference position, measured in detector pixels, of the central wavelength of interest and the reference wavelength, respectively,
   determine a value of the central wavelength of interest on the basis of a difference between said position of interest and reference position, of said known value of the reference wavelength and of a linear dispersion of the detecting system.

According to one embodiment, the measuring system is configured so that the detector detects the sample signal and the reference signal simultaneously, the reference source having a reference wavelength located outside the spectral line of interest.

According to another embodiment, the measuring system is configured so that the detector detects sequentially in time said sample signal for a signal duration and said reference signal for a reference duration, the signal duration and the reference duration being separated by a duration called the intermediate duration.

According to one embodiment, the sample signal is pulsed.

According to one embodiment, the measuring system according to the invention further comprises a pulsed laser configured to illuminate the sample so as to generate said sample signal.

According to one embodiment, the sample signal is emitted by a plasma and the system according to the invention further comprises an optical system configured to inject a portion of said light signal generated by the sample into the first entrance of the optical fiber.

According to one embodiment, the system according to the invention is configured to measure an isotopic abundance of an element present in the sample. The central wavelength of interest corresponds to a line resulting from contributions of two isotopes of said element, the value of the central wavelength of interest allowing said abundance to be determined.

According to another aspect, the invention relates to a first method for determining a central wavelength of interest of a spectral line of interest measured by a spectrometer,
the spectral line of interest corresponding to emission or absorption by a sample to be characterized, a light signal generated by the sample being called the sample signal, the spectral line of interest having either a bell profile, said central wavelength of interest then corresponding to the apex of said bell profile, or a double bell profile, said central wavelength of interest then corresponding to the trough between the two bells, the spectrometer being associated with a detector comprising a plurality of pixels aligned in an X-direction, the spectral line of interest being detected on detector pixels.

The method comprises the steps of:
providing a Y-shaped optical fiber having a first entrance, a second entrance and an exit,
providing a reference source emitting a light signal, called the reference signal, the reference source having a reference spectral line having a central wavelength, called the reference wavelength, of known value, the reference wavelength being selected so as to be detected on at least one pixel of the detector,
positioning the optical fiber such that the first entrance collects the sample signal, the second entrance collects the reference signal, and the exit is coupled to an input of the spectrometer,
detecting simultaneously in time said sample signal and said reference signal, so as to generate a measured profile of interest and a measured reference profile,
processing said measured profile of interest and measured reference profile so as to determine a position of interest and a reference position, of the central wavelength of interest and the reference wavelength, respectively,
determining a value of the central wavelength of interest on the basis of a difference between said position of interest and reference position, of said known value of the reference wavelength and of a linear dispersion of the spectrometer and of the associated detector.

The invention also relates to a second method for determining a central wavelength of interest of a spectral line of interest measured by a spectrometer,
the spectral line of interest corresponding to emission or absorption by a sample to be characterized, a light signal generated by the sample being called the sample signal, the spectral line of interest having either a bell profile, said central wavelength of interest then corresponding to the apex of said bell profile, or a double bell profile, said central wavelength of interest then corresponding to the trough between the two bells, the spectrometer being associated with a detector comprising a plurality of pixels aligned in an X-direction, the spectral line of interest being detected on detector pixels.

The method comprises the steps of:
providing a Y-shaped optical fiber having a first entrance, a second entrance and an exit,
providing a reference source emitting a light signal, called the reference signal, the reference source having a reference spectral line having a central wavelength, called the reference wavelength, of known value, the reference wavelength being selected so as to be detected on at least one pixel of the detector,
positioning the optical fiber such that the first entrance collects the sample signal, the second entrance collects the reference signal, and the exit is coupled to an input of the spectrometer,
detecting sequentially in time said sample signal for a signal duration and said reference signal for a reference duration, so as to generate a measured profile of interest and a measured reference profile, the signal duration and the reference duration being separated by a duration called the intermediate duration,
processing said measured profile of interest and measured reference profile so as to determine a position of interest and a reference position, of the central wavelength of interest and the reference wavelength, respectively,
determining a value of the central wavelength of interest on the basis of a difference between said position of interest and reference position, of said known value of the reference wavelength and of a linear dispersion of the spectrometer and of the associated detector.

According to one embodiment, the intermediate duration is less than 5 s.

According to one embodiment,
in the step of sequential detection, an additional detection of the reference signal, then called the additional reference signal, is carried out such that detection of the sample signal at a time to is flanked temporally by detection of reference signals, and such that an additional measured reference profile is generated, and
in the step of processing the measured profiles, an additional reference position is further determined, and a reference position called the intermediate reference position is determined at the time to by interpolation, on the basis of the reference position and of the additional reference position, and on the basis of a predetermined law of variation in the reference position as a function of time,
the step of determining the central wavelength of interest then being carried out on the basis of a difference between said position of interest and intermediate reference position.

According to one embodiment, the processing step comprises the substep of adjusting values of the measured profile of interest and measured reference profile with known mathematical functions so as to determine by interpolation said position of interest and reference position with a precision better than one pixel.

According to one embodiment, the light signal generated by the sample is pulsed.

According to one embodiment, the light signal generated by the sample comes from an emission of a plasma emitted by the sample illuminated by a pulsed laser.

According to one embodiment, the methods according to the invention are configured to determine an isotopic abundance of an element present in said sample, said central wavelength of interest corresponding to a line resulting from contributions of two isotopes of said element, said value of the central wavelength of interest allowing said abundance to be determined.

The following description presents a number of examples of embodiment of the device of the invention: the scope of the invention is not limited to these examples. These examples of embodiment have both essential features of the invention and additional features related to the embodiments in question.

### BRIEF DESCRIPTION OF THE DRAWINGS

The invention will be better understood and other features, aims and advantages thereof will become apparent from the following detailed description and with reference to the appended drawings, which are given by way of non-limiting example, and in which:

FIG. 1, which has already been described, illustrates the principle of measurement using LIBS, LAMIS and LIBRIS technologies;

FIG. 2, which has already been described, illustrates a spectral line measured in a case where the concentration of the element in the plasma is low, the effect of self-absorption then being little marked or even negligible;

FIG. 3, which has already been described, illustrates a spectral line measured in a case where the concentration of the element in the plasma is high, the effect of self-absorption then being marked;

FIG. 4, which has already been described, illustrates the variation in the measured central wavelength λ0 as a function of the isotopic abundance of the isotope 6Li of lithium in the sample;

FIG. 5 illustrates a system for measuring a central wavelength of interest according to the invention;

FIG. 6 illustrates the measured profile of interest and the measured reference profile;

FIG. 7 illustrates a system according to the invention in a LIBRIS context, i.e. it is configured to measure an isotopic ratio of an element present in the sample;

FIG. 8 illustrates the method for determining a central wavelength of interest according to the invention;

FIG. 9 illustrates the theoretical reference profile and theoretical profile of interest that best fit the experimental points of the measured reference profile and measured profile of interest, respectively;

FIG. 10 illustrates the data obtained by repeating the measurement 18 times (measurements n°i numbered from 1 to 18): for each measurement i, on the one hand a raw value (cross) is determined, and on the other hand a corrected value (dots) determined according to the method according to the invention is determined;

FIG. 11 shows the mean and standard deviation of these 18 measurements in both cases (raw and corrected values).

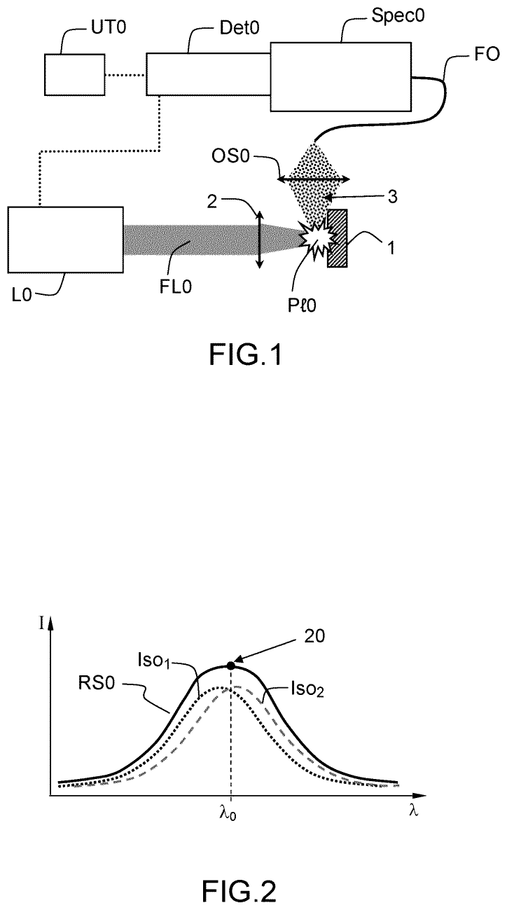

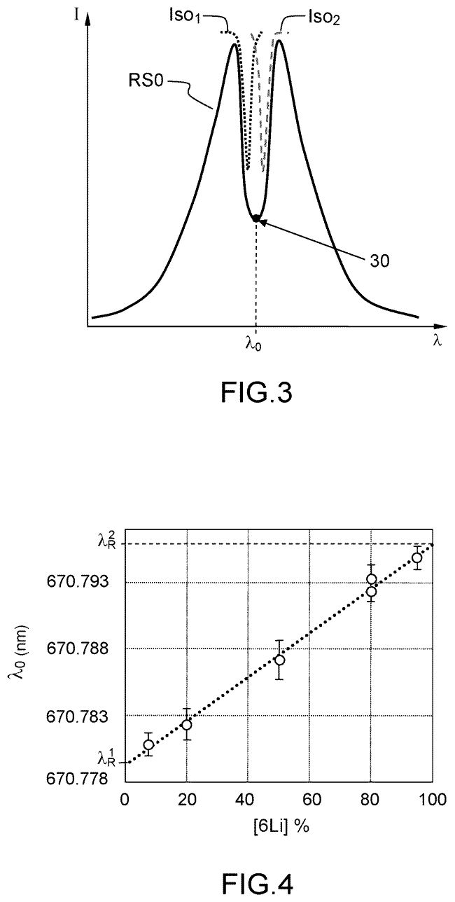

### DETAILED DESCRIPTION

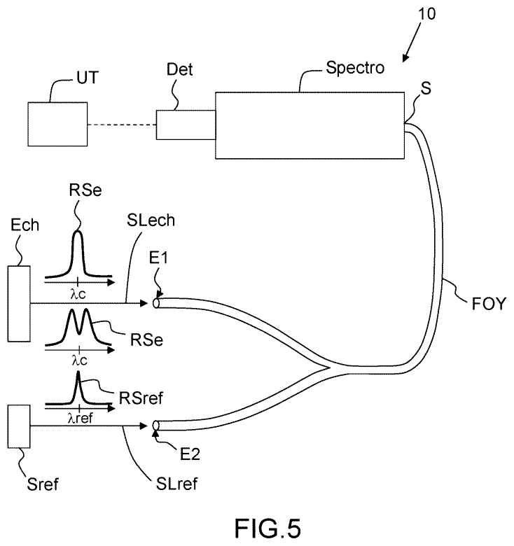

The invention relates to a system 10 for measuring a central wavelength of interest λc of a spectral line of interest RSe measured by a spectrometer, as illustrated in FIG. 5. The invention also relates to a method 100 for measuring the central wavelength.

The invention is applicable to LIBS or to any other spectroscopic technique, regardless of the pressure employed, provided that it is necessary to measure a wavelength precisely. In LIBS/LAMIS this is the case for physical applications where it is advantageous to determine the wavelength precisely, for example when it is a question of measuring the spectral shift of a line due to the Stark effect or the Doppler effect. The invention is also applicable to LIBRIS, for which it is particularly suitable.

The spectral line of interest corresponds to emission or absorption by a sample Ech to be characterized, and the light signal generated by the sample is called the sample signal SLech. The spectral line has either a bell profile, λc then corresponding to the wavelength of the apex of the bell profile, or a double bell profile, λc then corresponding to the wavelength of the trough between the two bells.

Different physical effects may be behind the excitation of the sample used to generate the sample signal. For example, a plasma is produced that emits the sample signal. According to one embodiment, the sample is illuminated by a pulsed laser. According to other embodiments, the emission of the sample is induced by an excitation source other than a pulsed laser, for example an electric discharge as in spark spectrometry or a glow discharge. The plasma may also be an inductive plasma.

According to one embodiment, the sample signal is pulsed. According to one embodiment, the system 10 according to the invention also comprises a pulsed laser L configured to illuminate the sample. In response to this illumination, via a physical effect, such as the emission of a plasma inter alia, the illuminated sample emits the pulsed light signal SLech to be characterized.

The system 10 according to the invention comprises a detecting system comprising a spectrometer Spectro associated with (or comprising) a detector Det, this detector comprising a plurality of pixels Pi aligned in an X-direction. The spectral line of interest RSe is detected on detector pixels.

The system 10 also comprises a reference source Sref that emits a light signal called the reference signal SLref. The reference source has a reference spectral line RSref having a central wavelength called the reference wavelength of known value λref. The reference wavelength is selected so as to be detected on at least one pixel of the detector. The reference source Sref is independent of the sample excitation source causing the sample signal SLech to be generated.

The system 10 also comprises a Y-shaped optical fiber FOY, having a first entrance E1 and a second entrance E2 and an exit S.

The optical fiber FOY is positioned and the system 10 is configured such that the first entrance E1 of the fiber collects the light signal SLech generated by the sample, and the second entrance E2 of the fiber collects the light signal SLref generated by the reference source. The lines RSe and RSref are thus detected on the detector in the same spectrometer configuration (same adjustment). The reference source is selected depending on the spectral characteristics of the sample to be analyzed.

In addition, the exit S of the fiber is coupled to an input of the spectrometer.

By virtue of the Y-shaped fiber, the spectrometer and the detector may receive both signals SLech and SLref simultaneously.

The system 10 according to the invention is configured so that the detector Det detects simultaneously (first variant) or sequentially in time (second variant) the sample signal SLech and the reference signal SLref.

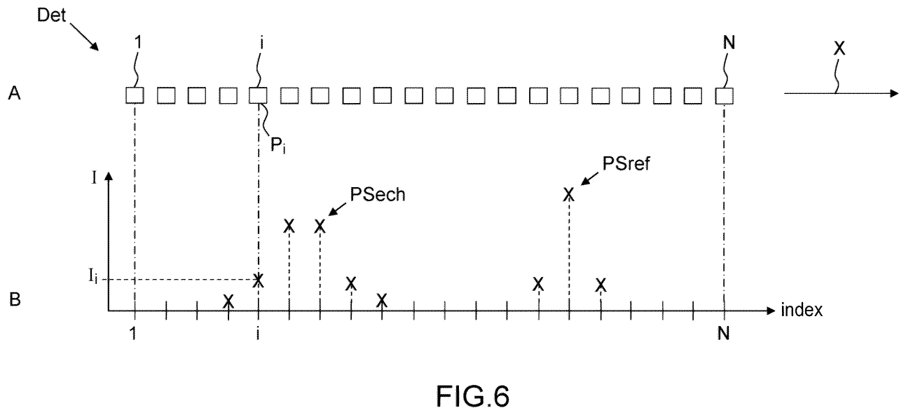

This detection generates a measured profile of interest PSech and a measured reference profile PSref as illustrated in FIG. 6. The x-axis of the profiles is the index i of the pixels Pi of the detector and the y-axis is an intensity Ii detected by each pixel.

Lastly, the system comprises a processing unit UT configured to process the measured profile of interest and measured reference profile so as to determine a position of interest Pech of the central wavelength of interest λc and a reference position Pref of the reference wavelength λref, these being measured in detector pixels.

On the basis of the difference between the positions Pech-Pref, of the value of Aref, which is known with precision, and of DL, the linear dispersion of the detecting system [spectrometer+detector], the value of λ0 is determined, typically with formula (1). It is of course recommendable to use the value of DL corresponding to the spectral region in which λref and λ0 are located.

Because of the instantaneity or quasi-instantaneity of detection of the two spectra PSech and PSref, the aforementioned wavelength drift is thus also made negligible and a very good sub-picometric precision in the value of λ0 is obtained.

According to the first variant, the two measured profiles (spectrum of interest and reference spectrum) are acquired simultaneously. For this purpose, it is recommendable for the reference source to have a reference wavelength located outside the spectral line of interest. If such is not the case, the reference signal may interfere with the sample signal.

In the particular case of LIBRIS, the plasma signal is intense and of short duration. Preferably, the reference source should be intense enough that the optimized acquisition parameters of the detector for detection of each spectrum are identical.

According to the second variant, the two profiles are acquired sequentially in time. The detector Det detects said sample signal for a signal duration Ds and said reference signal for a reference duration Dref. The signal duration and the reference duration are separated by a duration called the intermediate duration Dint, which it is sought to minimize.

The time sequence defined by [signal SLech during Ds/Dint/signal SLref during Dref], as illustrated in FIG. 5, is denoted ST. Of course, it is also possible to invert the signals SLech and SLref in the sequence.

The exposure times Ds and Dref are adjusted depending on SLech and SLref, respectively, so that the signal-to-noise ratio is sufficient for good detection of each signal.

In this second variant, the reference wavelength may be identical to the central wavelength of interest, which is for example the case of a lithium hollow-cathode lamp in the context of LIBRIS analysis of lithium.

The signals SLref and SLech generally have very different intensity profiles as a function of time. Sref, typically a hollow-cathode lamp, emits few photons continuously. According to one preferred embodiment, the signal SLech is a pulsed signal, which is typically intense and of short duration (large quantity of photons for a very short time, for example the plasma signal).

Due to this difference in intensity profile, in practice a single acquisition for simultaneous detection by Det of the two spectral profiles is not possible, as the detection of each type of profile requires a different detection configuration. Thus, for the typical case in which the reference source emits weakly but continuously, while the plasma emits intensely for a short time, the optimized acquisition parameters for detection of each of the spectra cannot be identical, and sequential detection is necessary.

Preferably, Ds<Dref.

Thus, the system according to the invention is configured so that the detector successively detects the two spectra with different acquisition parameters.

These parameters are (non-exhaustive list): delay of the measurement with respect to the laser shot (for the sample signal only), width of the acquisition time gate, number and rate of accumulations, detector gain, signal averaging.

These parameters are for example as follows:

TABLE II

| | Sample | Reference |
|---|---|---|
| Delay of the measurement | 1 μs | Not applicable |
| with respect to the laser shot | | |
| Width of the acquisition | 500 ns | 200 ms |
| time gate | | |
| Number and rate of | 20 to 20 Hz | 10 to 3 Hz |
| accumulations | | |
| Detector gain | 3000 | 3000 |
| Signal averaged over . . . | 10 acquisitions | 1 acquisition |

Preferably, the detector is an intensified CCD detector.

The separation between the two measurements, corresponding to Dint, may be made negligible with respect to the risk of drift in the wavelength of the detecting system (preferably Dint<5 s, or even Dint<1 s).

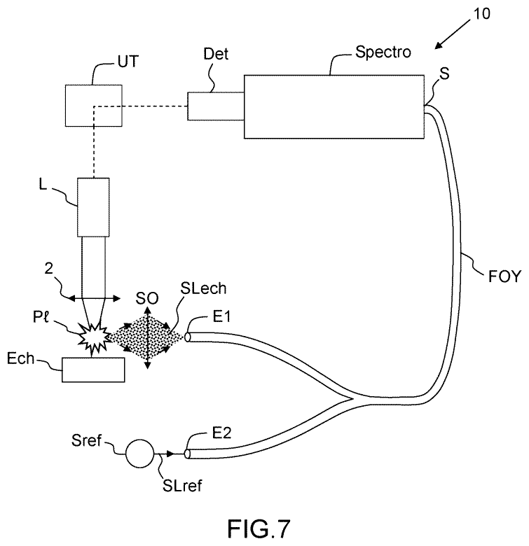

According to one embodiment illustrated in FIG. 7, the light signal SLech is due to an emission of a plasma PI emitted by the sample Ech, illuminated by a pulsed laser L. The system 10 according to the invention then comprises, in addition to the laser L, an optical system 2 that focuses the laser beam onto the sample and an optical system SO configured to inject some of the light signal generated by the sample into the first entrance E1 of the optical fiber.

According to one embodiment, the processing unit UT is further configured to synchronize the detector Det with the laser L for detection of the sample signal.

According to one embodiment, the system 10 according to the invention is associated with implementation of the LIBRIS technology, i.e. it is configured to measure an isotopic ratio of an element present in the sample Ech. The central wavelength of interest corresponds to a line resulting from contributions of two isotopes of the element, and the value of the central wavelength of interest makes it possible to determine the isotopic abundance as explained above.

The duration of detection of SLech is determined depending on the duration of the laser pulse and on the laser frequency f. Typically Ds is of the order of 1 μs. According to a first variant, the method 100 for determining the central wavelength of interest λc of a spectral line of interest RSe measured by a spectrometer comprises the following steps.

A Y-shaped optical fiber OFY having a first entrance E1, a second entrance E2 and an exit S is provided, and a reference source Sref emitting the reference signal and having a reference spectral line RSref having a central wavelength called the reference wavelength of known value λref is provided, the reference wavelength being selected so as to be detected on at least one pixel of the detector.

The optical fiber OFY is then positioned such that the first entrance collects the sample signal, the second entrance collects the reference signal, and the exit is coupled to an input Espec of the spectrometer.

Next, the sample signal SLech and the reference signal SLref are detected simultaneously, so as to generate a measured profile of interest PSech and a measured reference profile PSref.

Next, the measured profile of interest and measured reference profile are processed so as to determine a position of interest Pech and a reference position Pref, measured in detector pixels, of the central wavelength of interest and the reference wavelength, respectively,

Lastly, a value of the central wavelength of interest is determined on the basis of a difference between the position of interest and reference position, of the known value of the reference wavelength and of the linear dispersion DL of the detecting system (spectrometer+detector).

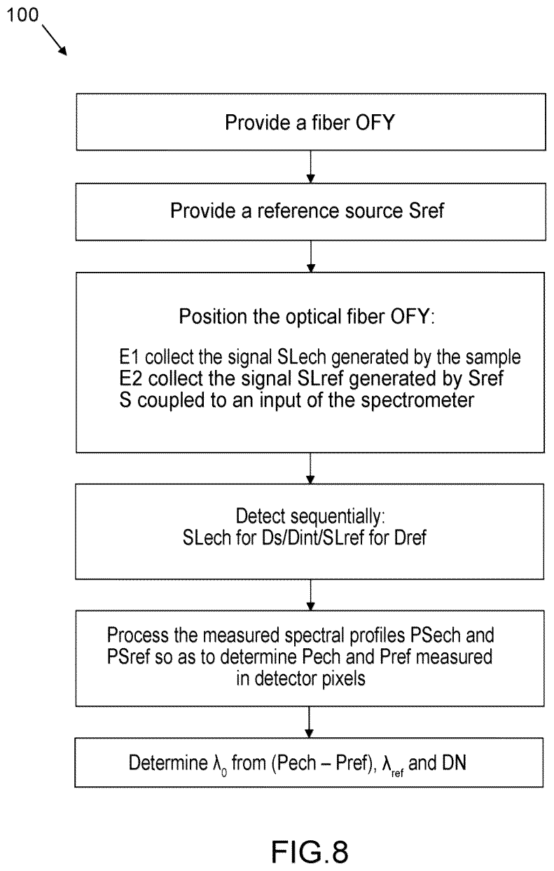

According to a second variant, illustrated in FIG. 8, in the method 200 for determining the central wavelength of interest λc, the sample signal SLech and the reference signal SLref are detected sequentially in time, during the signal duration Ds and reference duration Dref, respectively, rather than both signals being detected simultaneously. The signal duration and the reference duration are separated by a predetermined duration called the intermediate duration Dint. The other steps are identical.

According to one embodiment of the method 200, the time sequence is obtained with shutters O1 and O2 placed in front of the entrances E1 and E2 and programmed to adjust the durations Ds, Dref and Dint. When SLech is a pulsed signal of frequency f, the shutter O1 is synchronized with the frequency of the signal SLref, to let pass the desired number of pulses, and the shutter O2 is configured to transmit the signal SLech for a sufficient duration Dech, before or after the shutter O1 is activated, with a time Dint between the activation of the two shutters that is as small as possible and limited by the speed of the electronics of the detecting system.

According to one embodiment, the sample signal comes from an emission of a plasma emitted by the sample illuminated by a pulsed laser. According to one embodiment, the method is configured to measure the isotopic abundance of an element present in the sample. The central wavelength of interest then corresponds to a line resulting from the contributions of the two isotopes of the element and its value makes it possible to determine abundance, as described above.

According to one embodiment, to obtain the time sequence, in a calibration pre-step, the brightness of Sref is adjusted so that the intensity of SLref detected during the time Ds is negligible, i.e. not detectable over noise.

For implementation of the time sequence ST, provision is made for the signal SLech to correspond to the last shot of the laser L and the detector is synchronized with the last shot. The duration Ds is of the order of 1 μs or 10 μs and limited by the frequency f of the laser. Next, after a duration Dint that may be very short, the detector is configured to detect SLref during a time window Dref typically of the order of 1 s or a few s. In this embodiment there is no need for shutters, the signal SLref is always present on the detector even during the detection of SLech, SLref being negligible in the time window Ds and it is the detector Det that is programmed in this case depending on the time sequence. The value of Dint is also limited by the speed of the electronics of the detecting system.

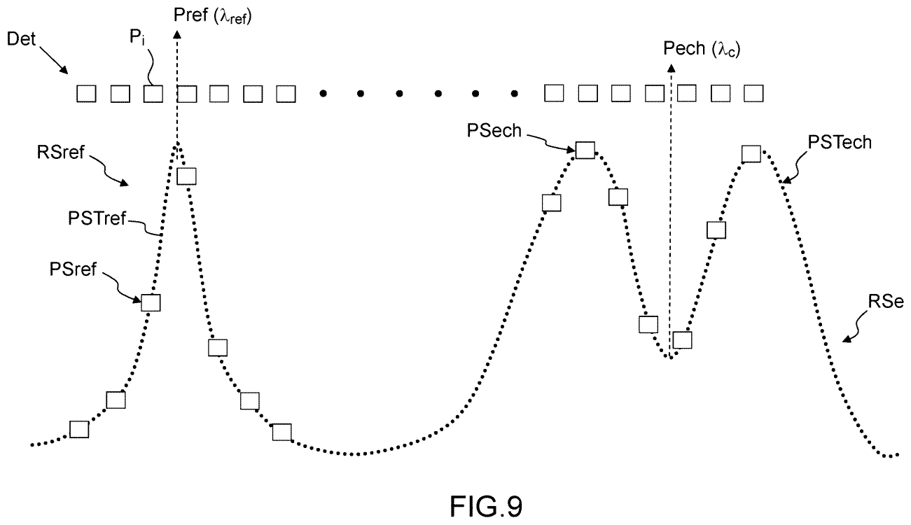

In order to be able to measure λc with very high precision, it is sought to obtain its position Pech with a precision better than one detector pixel. To do this, according to one embodiment, the processing step comprises the substep of adjusting the values of the measured reference profile PSref and measured profile of interest PSech with known mathematical functions so as to determine by interpolation the position of interest and reference position with a precision better than one pixel. Thus, a theoretical reference profile PSTref and a theoretical profile of interest PSTech that best fit the experimental points are determined, as illustrated in FIG. 9. Typically, the mathematical functions used are selected from: Gaussian, Lorentzian and Voigt profiles.

By virtue of these profiles, the positions Pref and Pech are determined in fractions of pixels (typically with precision to the second decimal).

According to an embodiment allowing an even more precise measurement, the sequential detection step further comprises an additional detection of the reference signal, then called the additional reference signal Sref/add, such that detection of the sample signal at a time t₀ is flanked temporally by detection of the reference signal Sref, for example at t₁<t₀, and the additional reference signal Sref/add at t₂>t₀.

The sequence ST is then for example: signal SLref during Dref/Dint/signal SLech during Ds/Dint/signal SLref/add during Dref.

In this detecting step, an additional measured reference profile PSref/add corresponding to the signal SLref/add is also generated.

In the step of processing the measured profiles, an additional reference position Pref/add is further determined. Of course, the fit to a theoretical curve may be applied to determine Pref/add. Due to the drift of the spectrometer, the positions Pref and Pref/add are slightly different.

In the processing step, the reference position called the intermediate reference position P0ref is in addition determined at the time t0 by interpolation, on the basis of the reference position Pref and of the additional reference position Pref/add, and on the basis of a predetermined law of variation in the reference position as a function of time, typically considered linear. By virtue of this interpolation, the drift of the spectrometer between the times t₁ and t₀ or between the times t₀ and t₂ is corrected. The position P0ref is thus more precise than the Pref obtained via a single detection of the spectrum of the reference source at a time prior to or subsequent to t₀. This is equivalent to the case of quasi-instantaneity of detection of the reference and sample.

In this particular embodiment, the step of determining the central wavelength of interest is then performed on the basis of the difference Pech−P0ref.

In the linear case, the following is obtained:

P_{ref}(t₀)=P0_{ref}=a·t₀+b (2)

Parameters a and b are determined from measurements at the times t₁ and t₂:

$$a = \frac{{P}_{ref} ( {t}_{2} ) - {P}_{ref} ( {t}_{1} )}{{t}_{2} - {t}_{1}} = \frac{{P}_{ref / add} - {P}_{ref}}{{t}_{2} - {t}_{1}} \qquad ( 3 )$$

$$b = {P}_{ref} ( {t}_{2} ) - a \cdot {t}_{2} \qquad ( 4 )$$

Below, results illustrating the advantageousness of the proposed correcting method are briefly presented. A Jobin Yvon THR1000 spectrometer equipped with a grating of 2400 lines/mm centered at 670 nm was used. The detector was an Andor iStar intensified camera of 2048×512 pixels, with a linear dispersion DL of 2.774 μm/pixel at 670 nm.

A line of a mercury vapor lamp was measured in the presence of spectrometer drift, the line of the mercury vapor source forming the spectral line of interest.

Next (or beforehand), the line of the reference source, which was a lithium hollow-cathode lamp (HCL), was measured, which line was known with precision and equal to λref=670.776 nm.

The drift of the spectrometer was then corrected using the method 100 according to the invention (simultaneous detection). Specifically, in this case, the lines of the two sources are sufficiently separated in wavelength and of comparable intensity, and hence simultaneous measurement is possible.

The acquisition parameters are given in table III below.

TABLE III

| Width of the acquisition time gate | 50 ms |
|---|---|
| Number and rate of accumulations | 100 to 18 Hz |
| Detector gain | 4000 |

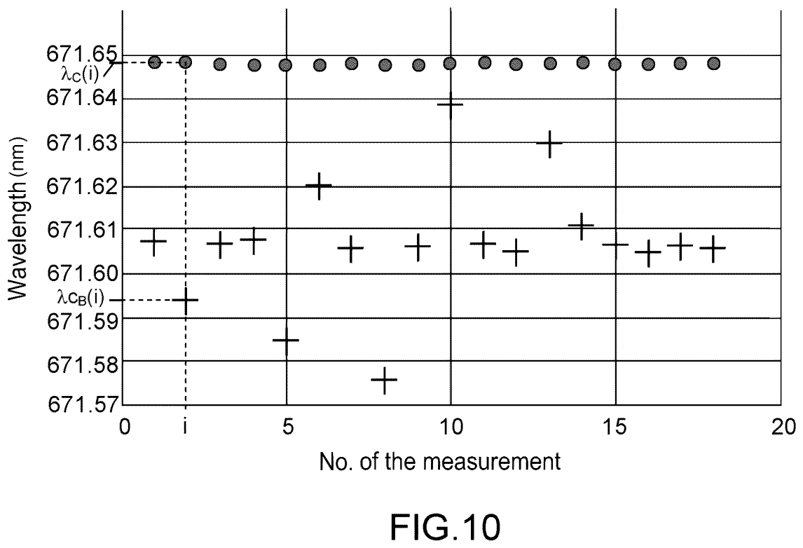

The graph of FIG. 10 illustrates the data obtained by repeating the measurement 18 times (measurements i numbered from 1 to 18). For each measurement i the following were determined: on the one hand a raw value λc_{B}(i) (cross), and on the other hand a corrected value λc (i) (dots) determined according to the method 100 according to the invention. The raw values were obtained by direct measurement with the detecting system. The dispersion in the raw data may be seen and results from the drift of the spectrometer. The corrected values of λc are very little dispersed over the 18 measurements.

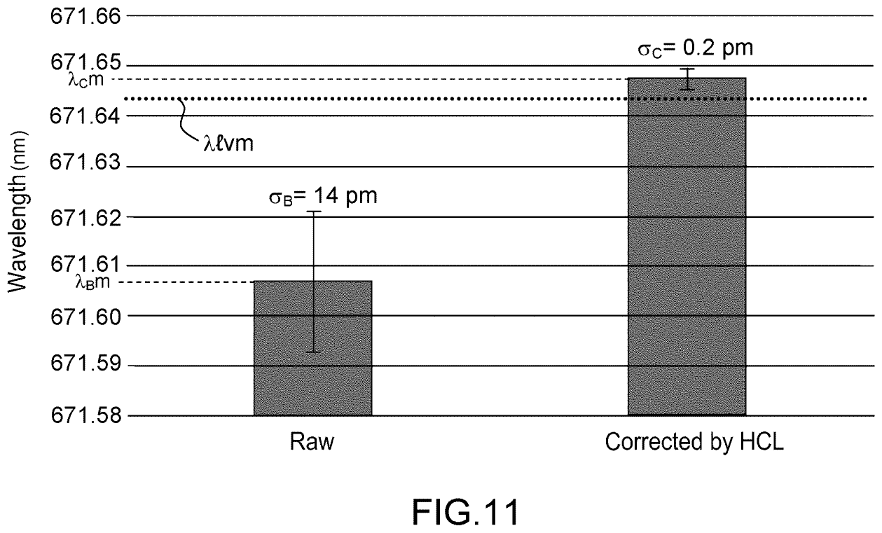

FIG. 11 shows the mean and standard deviation σ of these 18 measurements in both cases, raw and corrected with Aref of the HCL lamp, respectively (λ_{B}M, σ_{B}) and (λ_{c}m, σ_{c}). The “true” value of the wavelength of the mercury vapor lamp, which moreover is known very precisely, is λₗᵥₘ=671.643 nm. This value is also shown in FIG. 11 and makes it possible to test the relevance of the method according to the invention. The value λ_{c}m is much closer to λₗᵥₘ than the value λ_{B}m. It may be seen that the measuring method according to the invention significantly improves the accuracy and fidelity of the measured wavelength.

1. A system for measuring a central wavelength of interest (λc) of a spectral line of interest (RSe) measured by a spectrometer, the spectral line of interest corresponding to emission or absorption by a sample (Ech) to be characterized, a light signal generated by the sample being called the sample signal (SLech), the spectral line of interest having either a bell profile, said central wavelength of interest then corresponding to the apex of said bell profile, or a double bell profile, said central wavelength of interest then corresponding to the trough between the two bells, the system comprising:
a detecting system comprising a spectrometer (Spectro) associated with a detector (Det) comprising a plurality of pixels (Pi) aligned in an X-direction, the spectral line of interest being detected on detector pixels,
a reference source (Sref) emitting a light signal, called the reference signal (SLref), the reference source having a reference spectral line (RSref) having a central wavelength, called the reference wavelength, of known value (λref), the reference wavelength being selected so as to be detected on at least one pixel of the detector,
a Y-shaped optical fiber (FOY) having a first entrance (E1), a second entrance (E2) and an exit(S), the optical fiber being configured such that:
the first entrance collects the sample signal (SLech),
the second entrance collects said reference signal (SLref),
the exit is coupled to an input of the spectrometer,
the measuring system being configured so that the detector detects said sample signal and said reference signal simultaneously or sequentially in time, so as to generate a measured profile of interest (PSech) and a measured reference profile (PSref),
the measuring system further comprising a processing unit (UT) configured to:
process said measured profile of interest and measured reference profile so as to determine a position of interest (Pech) and a reference position (Pref), measured in detector pixels, of the central wavelength of interest and the reference wavelength, respectively,
determine a value of the central wavelength of interest on the basis of a difference between said position of interest and reference position, of said known value of the reference wavelength and of a linear dispersion (DL) of the detecting system.

2. The measuring system as claimed in claim 1, wherein the measuring system is configured so that the detector detects said sample signal and said reference signal simultaneously, the reference source having a reference wavelength located outside the spectral line of interest.

3. The measuring system as claimed in claim 1, wherein the measuring system is configured so that the detector detects sequentially in time said sample signal for a signal duration (Ds) and said reference signal for a reference duration (Dref), the signal duration and the reference duration being separated by a duration called the intermediate duration (Dint).

4. The measuring system as claimed in claim 1, wherein the sample signal is pulsed.

5. The measuring system as claimed in claim 1, further comprising a pulsed laser (L) configured to illuminate the sample so as to generate said sample signal.

6. The measuring system as claimed in claim 1, wherein the sample signal is emitted by a plasma (Pl) and further comprising an optical system (SO) configured to inject a portion of said light signal generated by the sample into the first entrance of the optical fiber.

7. The measuring system as claimed in claim 6, configured to measure an isotopic abundance of an element present in the sample, wherein said central wavelength of interest corresponds to a line resulting from contributions of two isotopes of said element, said value of the central wavelength of interest allowing said abundance to be determined.

8. A method for determining a central wavelength of interest (λc) of a spectral line of interest (RSe) measured by a spectrometer, the spectral line of interest corresponding to emission or absorption by a sample (Ech) to be characterized, a light signal generated by the sample being called the sample signal (SLech), the spectral line of interest having either a bell profile, said central wavelength of interest then corresponding to the apex of said bell profile, or a double bell profile, said central wavelength of interest then corresponding to the trough between the two bells, the spectrometer being associated with a detector (Det) comprising a plurality of pixels (Pi) aligned in an X-direction, the spectral line of interest being detected on detector pixels, the method comprising the steps of:
providing a Y-shaped optical fiber (OFY) having a first entrance (E1), a second entrance (E2) and an exit(S),
providing a reference source (Sref) emitting a light signal, called the reference signal (SLref), the reference source having a reference spectral line (RSref) having a central wavelength, called the reference wavelength, of known value (Aref), the reference wavelength being selected so as to be detected on at least one pixel of the detector, positioning the optical fiber such that the first entrance collects the sample signal, the second entrance collects the reference signal, and the exit is coupled to an input (Espec) of the spectrometer,
detecting simultaneously in time said sample signal and said reference signal, so as to generate a measured profile of interest (PSech) and a measured reference profile (PSref),
processing said measured profile of interest and measured reference profile so as to determine a position of interest (Pech) and a reference position (Pref), of the central wavelength of interest and the reference wavelength, respectively,
determining a value of the central wavelength of interest on the basis of a difference between said position of interest and reference position, of said known value of the reference wavelength and of a linear dispersion (DL) of the spectrometer and of the associated detector.

9. A method for determining a central wavelength of interest (λc) of a spectral line of interest (RSe) measured by a spectrometer, the spectral line of interest corresponding to emission or absorption by a sample (Ech) to be characterized, a light signal generated by the sample being called the sample signal (SLech), the spectral line of interest having either a bell profile, said central wavelength of interest then corresponding to the apex of said bell profile, or a double bell profile, said central wavelength of interest then corresponding to the trough between the two bells, the spectrometer being associated with a detector (Det) comprising a plurality of pixels (Pi) aligned in an X-direction, the spectral line of interest being detected on detector pixels, the method comprising the steps of:
providing a Y-shaped optical fiber (OFY) having a first entrance (E1), a second entrance (E2) and an exit(S),
providing a reference source (Sref) emitting a light signal, called the reference signal (SLref), the reference source having a reference spectral line (RSref) having a central wavelength, called the reference wavelength, of known value (λref), the reference wavelength being selected so as to be detected on at least one pixel of the detector, positioning the optical fiber such that the first entrance collects the sample signal, the second entrance collects the reference signal, and the exit is coupled to an input (Espec) of the spectrometer,
detecting sequentially in time said sample signal for a signal duration (Ds) and said reference signal for a reference duration (Dref), so as to generate a measured profile of interest (PSech) and a measured reference profile (PSref), the signal duration and the reference duration being separated by a duration called the intermediate duration (Dint),
processing said measured profile of interest and measured reference profile so as to determine a position of interest (Pech) and a reference position (Pref), of the central wavelength of interest and the reference wavelength, respectively,
determining a value of the central wavelength of interest on the basis of a difference between said position of interest and reference position, of said known value of the reference wavelength and of a linear dispersion (DL) of the spectrometer and of the associated detector.

10. The method as claimed in claim 9, wherein the intermediate duration is less than 5 s.

11. The method as claimed in claim 9, wherein:
in the step of sequential detection, an additional detection of the reference signal, then called the additional reference signal (Sref/add), is carried out such that detection of the sample signal at a time t0 is flanked temporally by detection of reference signals, and such that an additional measured reference profile (PSref/add) is generated, and
in the step of processing the measured profiles, an additional reference position (Pref/add) is further determined, and a reference position called the intermediate reference position (P0ref) is determined at the time t0 by interpolation, on the basis of the reference position (Pref) and of the additional reference position (Pref/add), and on the basis of a predetermined law of variation in the reference position as a function of time,
the step of determining the central wavelength of interest then being carried out on the basis of a difference between said position of interest (Pech) and intermediate reference position (P0ref).

12. The method as claimed in claim 8, wherein the processing step comprises the substep of adjusting values of the measured profile of interest and measured reference profile with known mathematical functions so as to determine by interpolation said position of interest and reference position with precision better than one pixel.

13. The method as claimed in claim 7, wherein the light signal generated by the sample is pulsed.

14. The method as claimed in claim 13, wherein the light signal generated by the sample comes from an emission of a plasma emitted by the sample illuminated by a pulsed laser.

15. The method as claimed in claim 14, configured to determine an isotopic abundance of an element present in said sample, said central wavelength of interest corresponding to a line resulting from contributions of two isotopes of said element, said value of the central wavelength of interest allowing said abundance to be determined.
